(19) United States
(12) Patent Application Publication
(10) Pub. No.: US 2022/0416254 A1
(43) Pub. Date: Dec. 29, 2022

(54) CURRENT COLLECTING PLATE AND CYLINDRICAL LITHIUM BATTERY

(71) Applicant: SHENZHEN BAK POWER BATTERY CO., LTD., Shenzhen (CN)

(72) Inventor: Junfeng Zhao, Shenzhen (CN)

(21) Appl. No.: 17/778,915

(22) PCT Filed: Aug. 6, 2021
(86) PCT No.: PCT/CN2021/111287

§ 371 Date: May 23, 2022

(30) Foreign Application Priority Data
Oct. 29, 2020 (CN) 202011178413.0

(51) Int. Cl. H01M 4/70; H01M 10/052; H01M 50/107

(52) U.S. Cl. CPC H01M 4/70; H01M 10/052; H01M 50/107

(57) ABSTRACT

The present application provides a current collecting plate and a cylindrical lithium battery. The current collecting plate includes a circular current collecting plate, a center of the circular current collecting plate is provided with a central area, an edge of the circular current collecting plate is provided with at least one notch, and circumferences of concentric circles outside the central area of the circular current collecting plate are respectively provided with a liquid guiding hole, and each liquid guiding hole and the notch are configured for guiding liquid for to a battery electrode group at a bottom of the circular current collecting plate.

### CROSS REFERENCE TO RELATED APPLICATION

The present application is a National phase of international patent application No. PCT/CN2021/111287 with an international filling date of Aug. 6, 2021, designating the USA, now pending, and further claims priority of Chinese Invention Patent application, with Application No. 202011178413.0, filed on Oct. 29, 2020, the contents of all of the aforementioned application, including any intervening amendments thereto, are incorporated herein by reference.

### TECHNICAL FIELD

The present application relates to the technical field of lithium battery, and more particularly to a current collecting plate and a cylindrical lithium battery.

### BACKGROUND

With the development of economy and society, batteries, especially lithium batteries, are developing rapidly. Due to the high specific energy, long life, and green environmental protection, lithium batteries have attracted more and more attention, and the lithium batteries will have broad application prospects in electric vehicle power sources and energy storage power sources.

The existing cylindrical battery includes a battery case, an electrode group arranged in the battery case, a current collecting plate arranged at the end of the electrode group, and the current collecting plate is provided with several liquid guiding holes, the speed and uniformity of the electrolyte permeating the battery electrode group can be accelerated by the arrangement of the several liquid guiding holes. However, the liquid guiding is carried out through the liquid guiding holes on the current collecting plate, so that there is still an area under the current collecting plate that cannot get the electrolyte infiltrated at the first time, resulting in poor penetration consistency of the pole pieces, and the injection takes a long time.

### TECHNICAL PROBLEM

An object of an embodiment of the present application is to provide a current collecting plate, in order to solve the technical problem that the penetration consistency of the pole pieces of the cylindrical lithium battery in the art is poor, and the injection takes a long time.

### SUMMARY

In order to solve above object, the technical solution adopted in the present application is to provide a current collecting plate, which includes:

a circular current collecting plate, a center of the circular current collecting plate is provided with a central area, an edge of the circular current collecting plate is provided with at least one notch, and circumferences of concentric circles outside the central area of the circular current collecting plate are respectively provided with a liquid guiding hole, and each liquid guiding hole and the notch are configured for guiding liquid for to a battery electrode group at a bottom of the circular current collecting plate.

Further, a diameter of the liquid guiding hole of the concentric circles on an outer circle on the circular current collecting plate is larger than that of the liquid guiding hole on the concentric circles on an inner circle on the circular current collecting plate.

Further, the circular current collecting plate is provided with a plurality of grooves.

Further, each of the grooves extends along a radial direction of the circular current collecting plate.

Further, the grooves are formed by a top surface of the circular current collecting plate being recessed toward a bottom surface of the circular current collecting plate.

Further, a depth of each groove is greater than a thickness of the circular current collecting plate.

Further, the grooves are strip-shaped grooves.

Further, the circular current collecting plate is a positive electrode current collecting plate, and the central area is provided with a through hole.

Further, the notch is formed through a thickness direction of the circular current collecting plate.

The embodiment of the present application provides a cylindrical lithium battery, which includes the current collecting plate above-mentioned.

### BENEFICAL EFFECTS

The beneficial effect of the current collecting plate provided by the present application is that compared with the prior art, the current collecting plate of the present application is provided with liquid guiding holes and at least one notch is arranged on the edge of the circular current collecting plate, so that any concentric circular electrode sheet (battery electrode group) under the current collecting plate can form a liquid injection channel, then, the liquid injection channel can be formed in any concentric circular pole piece under the current collecting plate at the first time of liquid injection of the cylindrical lithium battery, so as to obtain the penetration of the electrolyte, which can effectively improve the consistency of the electrolyte penetration of the electrode sheet, reduce the time-consuming of liquid injection, and improve the product quality.

### BRIEF DESCRIPTION OF THE DRAWINGS

In order to illustrate the technical solutions in the embodiments of the present application more clearly, the following briefly introduces the accompanying drawings that need to be used in the description of the embodiments or the prior art. Obviously, the drawings in the following description are only for the present application. In some embodiments, for those of ordinary skill in the art, other drawings can also be obtained according to these drawings without any creative effort.

FIG. 1 is a schematic structural diagram of a current collecting plate provided by an embodiment of the present application as a positive electrode current collecting plate; and

FIG. 2 is a schematic structural diagram of a current collecting plate provided by an embodiment of the present application as a negative electrode current collecting plate.

The details of the symbols involved in the above drawings are as follows:

100—current collecting plate;

10—circular current collecting plate; 11—notch; 12—liquid guiding hole; 13—groove; 14—through hole; 15—central area.

### DETAILED DESCRIPTION

In order to make the technical problems, technical solutions and beneficial effects to be solved by the present application clearer, the present application will be described in further detail below with reference to the accompanying drawings and embodiments. It should be understood that the specific embodiments described herein are only used to explain the present application, but not to limit the present application.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

It is to be understood that the terms “length”, “width”, “upper”, “lower”, “front”, “rear”, “left”, “right”, “vertical”, “horizontal”, “top” , “bottom”, “inside”, “outside”, etc. indicate the orientation or positional relationship based on the orientation or positional relationship shown in the accompanying drawings, only for the convenience of describing the present application and simplifying the description, rather than indicating or implying the indicated a device or element must have a particular orientation, be constructed and operate in a particular orientation, and therefore should not be construed as a limitation of the present application.

In addition, the terms “first” and “second” are only used for descriptive purposes, and should not be construed as indicating or implying relative importance or implying the number of indicated technical features. Thus, a feature defined as “first” or “second” may expressly or implicitly includes one or more of that feature. In the description of the present application, “plurality” means two or more, unless otherwise expressly and specifically defined.

In order to illustrate the technical solutions described in the present application, a detailed description is given below with reference to the specific drawings and embodiments.

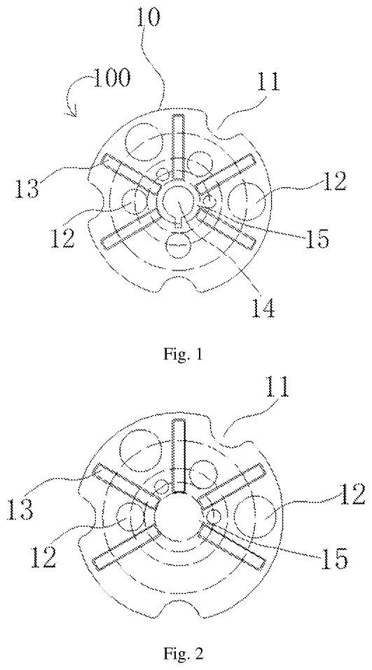

As shown in FIG. 1 and FIG. 2, an embodiment of the present application provides a current collecting plate 100, including a circular current collecting plate 10, a center of the circular current collecting plate 10 is provided with a central area 15, an edge of the circular current collecting plate 10 is provided with at least one notch 11, and circumferences of concentric circles of the circular current collecting plate 10 are respectively provided with a liquid guiding hole 2, and each liquid guiding hole 12 and the notch 11 are configured for guiding liquid for to a battery electrode group at a bottom of the circular current collecting plate 10.

The current collecting plate 100 provided in the embodiment of the present application is applied to a cylindrical lithium battery. The body of the current collecting plate is a circular current collecting plate 10, and at least one notch 11 is provided on the edge of the circular current collecting plate 10, or a plurality of notches 11 are arranged at intervals along the circumferential edge of the circular current collecting plate 10, and at the same time, liquid conducting holes 12 are respectively arranged on the circumferences of the concentric circles of the circular current collecting plate 10. When the battery electrode group (that is the concentric electrode sheets) on the bottom of the circular current collecting plate 10 is injected, the liquid can be guided through each concentric liquid guide hole 12 outside the central area of the circular current collecting plate 10 and the notch 11 at the edge of the circular current collecting plate 10, so that the cylindrical lithium battery can form a liquid injection channel for any concentric circular electrode piece under the current collecting plate 100 at the first time of liquid injection, and then obtain electrolyte penetration, which can effectively improve the consistency of electrode sheets electrolyte penetration, reduce the time-consuming of liquid injection, and improve product quality; therefore, the problem that in the prior art, when guiding liquid through the liquid guiding holes 12 on the current collecting plate, it is easy for a part of the area under the current collecting plate to fail to obtain electrolyte penetration for the first time, can be avoided.

In some embodiments of the present application, optionally, as shown in FIG. 1 and FIG. 2, the diameter of the liquid guiding hole 12 of the concentric circles on an outer circle on the circular current collecting plate 10 is larger than that of the liquid guiding hole 12 on the concentric circles on an inner circle on the circular current collecting plate 10.

In the embodiment, the diameter of the liquid guiding hole 12 of the concentric circles on an outer circle on the circular current collecting plate 10 is larger than that of the liquid guiding hole 12 on the concentric circles on an inner circle on the circular current collecting plate 10, that is, based on the center of the circular current collecting plate 10, a plurality of concentric circles are provided on the circular current collecting plate 10, the inner circle is the concentric circles with a smaller radius than the other concentric circles, and the outer circle is the concentric circles with a larger radius than the other concentric circles. With the diameter of the liquid guiding hole 12 of the concentric circles on the outer circle on the circular current collecting plate 10 is larger than that of the liquid guiding hole 12 on the concentric circles on the inner circle on the circular current collecting plate 10, the electrolyte of the electrode sheets under the current collecting plate can be penetrated more, since a plurality of outer circle electrode sheets are provided, which results in a large area and a large amount of electrolyte required. Therefore, the large-diameter liquid conducting holes 12 are adapted to the circular current collecting plate 10 to meet the requirements of the large area of the outer ring electrode sheet for electrolyte, to ensure product quality.

In some embodiments of the present application, optionally, as shown in FIG. 1 and FIG. 2, the circular current collecting plate 10 is provided with a plurality of grooves 13.

In the embodiment, the plurality of grooves 13 are provided on the circular current collecting plate 10, and the bottoms of the grooves 13 protrude from the bottom surface of the circular current collecting plate 10, in this way, the concave surface on the end surface of the battery electrode group below the circular current collecting plate 10 is matched, so that the current collecting plate and the end surface of the electrode group can be better positioned and fixed, which is convenient for laser welding, improves the production efficiency of the product, and reduces the production cost of the product and improves the market competitiveness of the product, compared with the end surface of the existing battery electrode group as a whole, the welding plate is formed after the whole end surface is flattened. The circular current collecting plate 10 is provided with the grooves 13 corresponding to the end surface of the battery electrode group to be flattened to facilitate welding, and other parts of the end surface of the battery electrode group are still in an upright state. It is easier to penetrate and improve the penetration efficiency of the electrolyte.

In the above-mentioned embodiment of the present application, optionally, as shown in FIG. 1 and FIG. 2, each of the grooves 13 is extended along the radial direction of the circular current collecting plate 10. Optionally, the grooves 13 are strip-shaped grooves.

In the embodiment, each groove 13 extends along the radial direction of the circular current collecting plate 10, that is, the center of the circular current collecting plate 10 is arranged in a reflective shape toward the circumferential direction of the circular current collecting plate 10, in this way, it is more stable and reliable when it is matched with the end surface of the electrode group.

In the above-mentioned embodiment of the present application, optionally, as shown in FIG. 1 and FIG. 2, the grooves 13 are formed by a top surface of the circular current collecting plate 10 being recessed toward a bottom surface of the circular current collecting plate 10. Optionally, a depth of each groove 13 is greater than a thickness of the circular current collecting plate 10.

In the embodiment, specifically, the grooves 13 are integrally formed by the top surface of the circular current collecting plate 10 being recessed toward the bottom surface thereof, so that the bottom of the groove 13 protrudes from the bottom surface of the circular current collecting plate 10, so that the grooves 13 form a convex structure on the bottom surface of the circular current collecting plate 10, so that it matches with the concave surface of the end surface of the electrode group, that is, the convex structure is inserted into the concave surface of the end surface of the electrode group to play the function of positioning and fixing.

In some embodiments of the present application, optionally, as shown in FIG. 1, the circular current collecting plate 10 is a positive current collecting plate, and the central area 15 is provided with a through hole 14.

In the embodiment, when the current collecting plate is the positive current collecting plate, the through hole 14 is provided in the central area 15 of the circular current collecting plate 10 to facilitate the insertion of the welding needle into the cell, and to complete the welding of the negative electrode liquid collecting sheet at the bottom of the cell and the battery shell, and the setting of the through hole 14 is used to facilitate the release of gas which is formed via electrochemical reactions during formation process, and the pressure inside the cylindrical lithium battery is released in time to ensure the safety of the battery.

In some embodiments of the present application, optionally, as shown in FIG. 1 and FIG. 2, the notches 11 are formed through the thickness direction of the circular current collecting plate 10.

In the embodiment, each notch 11 are in the shape of an arc, specifically, each notch 11 is a semicircle, and the semicircle notch 11 runs through the entire circular current collecting plate 10.

An embodiment of the present application provides a cylindrical lithium battery, including the current collecting plate 100 described in any of the above embodiments.

In some embodiments of the present application, optionally, a cylindrical lithium battery includes a battery case and an electrode group disposed in the battery case, and the current collecting plate 100 in any of the above embodiments is disposed at an end of the electrode group.

The cylindrical lithium battery provided by the embodiments of the present application has the current collecting plate 100 provided by any of the above embodiments, therefore, it has all the beneficial effects of the current collecting plate 100 provided by any of the above embodiments, and will not be repeated here.

Specifically, as shown in FIG. 1 and FIG. 2, the current collecting plate provided in this embodiment works as follows:

The current collecting plate is applied to the cylindrical lithium battery. The body of the current collecting plate is a circular current collecting plate 10, and a plurality of notches 11 are arranged on the edge of the circular current collecting plate 10, the notches are semicircular, and the notches are arranged at intervals along the circumferential edge of the circular current collecting plate 10, and at the same time, liquid guiding holes 12 are provided on the circumferences of the concentric circles of the circular current collecting plate 10 respectively. When the battery electrode group (that is the concentric electrode sheets) on the bottom of the circular current collecting plate 10 is injected, the liquid can be guided through each concentric liquid guide hole 12 outside the central area of the circular current collecting plate 10 and the notch 11 at the edge of the circular current collecting plate 10, so that the cylindrical lithium battery can form a liquid injection channel for any concentric circular electrode piece under the current collecting plate 100 at the first time of liquid injection, and then obtain electrolyte penetration, which can effectively improve the consistency of electrode sheets electrolyte penetration, reduce the time-consuming of liquid injection, and improve product quality; therefore, the problem that in the prior art, when guiding liquid through the liquid guiding holes 12 on the current collecting plate, it is easy for a part of the area under the current collecting plate to fail to obtain electrolyte penetration for the first time, can be avoided. In addition, the grooves 13 can also be provided on the circular current collecting plate 10, each groove 13 is extended along the radial direction of the circular current collecting plate 10, the grooves 13 are strip-shaped grooves, and the grooves 13 are formed by the top surface of the circular current collecting plate 10 being recessed toward the bottom surface thereof, and the depth of each groove 13 is greater than the thickness of the circular current collecting plate 10, so that it matches with the concave surface of the end surface of the electrode group, to make the current collecting plate and the end surface of the electrode group better positioned and fixed, which is convenient for laser welding, improves the production efficiency of the product, reduces the production cost of the product, and improves the market competitiveness of the product.

In summary, the current collecting plate and the cylindrical lithium battery provided by the present application are provided with liquid guiding holes and at least one notch is arranged on the edge of the circular current collecting plate, so that any concentric circular electrode sheet (battery electrode group) under the current collecting plate can form a liquid injection channel, then, the liquid injection channel can be formed in any concentric circular pole piece under the current collecting plate at the first time of liquid injection of the cylindrical lithium battery, so as to obtain the penetration of the electrolyte, which can effectively improve the consistency of the electrolyte penetration of the electrode sheet, reduce the time-consuming of liquid injection, and improve the product quality.

The above descriptions are only optional embodiments of the present application, and are not intended to limit the present application. Any modifications, equivalent replacements and improvements made within the principles of the present application shall be included within the protection scope of the present application.

1. A current collecting plate, comprising:
a circular current collecting plate, a center of the circular current collecting plate is provided with a central area, an edge of the circular current collecting plate is provided with at least one notch, and circumferences of concentric circles outside the central area of the circular current collecting plate are respectively provided with a liquid guiding hole, and each liquid guiding hole and the notch are configured for guiding liquid for to a battery electrode group at a bottom of the circular current collecting plate.

2. The current collecting plate according to claim 1, wherein a diameter of the liquid guiding hole of the concentric circles on an outer circle on the circular current collecting plate is larger than that of the liquid guiding hole on the concentric circles on an inner circle on the circular current collecting plate.

3. The current collecting plate according to claim 1, wherein the circular current collecting plate is provided with a plurality of grooves.

4. The current collecting plate according to claim 3, wherein each of the grooves extends along a radial direction of the circular current collecting plate.

5. The current collecting plate according to claim 3, wherein the grooves are formed by a top surface of the circular current collecting plate being recessed toward a bottom surface of the circular current collecting plate.

6. The current collecting plate according to claim 5, wherein a depth of each groove is greater than a thickness of the circular current collecting plate.

7. The current collecting plate according to claim 5, wherein the grooves are strip-shaped grooves.

8. The current collecting plate according to claim 1, wherein the circular current collecting plate is a positive electrode current collecting plate, and the central area is provided with a through hole.

9. The current collecting plate according to claim 1, wherein the notch is formed through a thickness direction of the circular current collecting plate.

10. A cylindrical lithium battery, comprising a current collecting plate, wherein the current collecting plate comprises:
a circular current collecting plate, a center of the circular current collecting plate is provided with a central area, an edge of the circular current collecting plate is provided with at least one notch, and circumferences of concentric circles outside the central area of the circular current collecting plate are respectively provided with a liquid guiding hole, and each liquid guiding hole and the notch are configured for guiding liquid for to a battery electrode group at a bottom of the circular current collecting plate.

11. The cylindrical lithium battery according to claim 10, wherein a diameter of the liquid guiding hole of the concentric circles on an outer circle on the circular current collecting plate is larger than that of the liquid guiding hole on the concentric circles on an inner circle on the circular current collecting plate.

12. The cylindrical lithium battery according to claim 10, wherein the circular current collecting plate is provided with a plurality of grooves.

13. The cylindrical lithium battery according to claim 12, wherein each of the grooves extends along a radial direction of the circular current collecting plate.

14. The cylindrical lithium battery according to claim 12, wherein the grooves are formed by a top surface of the circular current collecting plate being recessed toward a bottom surface of the circular current collecting plate.

15. The cylindrical lithium battery according to claim 14, wherein a depth of each groove is greater than a thickness of the circular current collecting plate.

16. The cylindrical lithium battery according to claim 14, wherein the grooves are strip-shaped grooves.

17. The cylindrical lithium battery according to claim 10, wherein the circular current collecting plate is a positive electrode current collecting plate, and the central area is provided with a through hole.

18. The cylindrical lithium battery according to claim 10, wherein the notch is formed through a thickness direction of the circular current collecting plate.
